(19) United States
(12) Patent Application Publication
(10) Pub. No.: US 2019/0102821 A1
(43) Pub. Date: Apr. 4, 2019

(54) EVENT PLANNING AND COLLECTIVE FUNDING METHOD AND SYSTEM

(71) Applicant: BB WEBB, Bozeman, MT (US)

(72) Inventor: BB WEBB, Bozeman, MT (US)

(21) Appl. No.: 15/721,897

(22) Filed: Sep. 30, 2017

(51) Int. Cl. G06Q 30/06

(52) U.S. Cl. CPC G06Q 30/0635; G06Q 40/12; G06Q 30/0605

(57) ABSTRACT

Method for a service registry provider, to provide a system that allows an event organizer, to plan and arrange for the collective funding of event day services. The service registry allows an event organizer to select contributors to receive information about an event, and further provides means to allow said contributors to purchase event day related services. Contributors are given means to access the event organizer's service registry, which is online database, where the available event day services can be purchased by contributors. The event organizer then receives the benefit of the event day services and items purchased by the third-party contributors at a selected event, without incurring the typical high cost of organizing an event that includes said services and items.

### FIELD OF THE INVENTION

The present invention relates generally to online event planning systems, and more particularly to collectively financing the cost of an event.

### BACKGROUND OF THE INVENTION

Although the invention described below is useful for any type of event, it would be particularly useful in connection with weddings or other types of special events, including, but not limited to birthdays, anniversaries, showers, and the like. Therefore, the background of the manner in which such services are traditionally secured for a wedding or other such event will initially be described.

Traditionally with regards to a wedding, a bride's family pays for the majority of the costs associated with a wedding This includes such items as wedding dresses and accessories, as well as the bride's gifts to her bridesmaid and groom, the wedding planner or coordinator, invitations and all its corresponding stationery, flowers, total reception costs including food and venue costs, all photography and videography expenses, the groom's wedding ring, music for the ceremony and the reception, any rentals, the bridesmaid's luncheon, accommodation for all bridesmaids and all transportation needed for the big day. Additionally, the bride's family pays for the cost of the engagement party.

As for the groom and his family's traditional expenses, they tend to be significantly less costly. Traditional costs include the bride's engagement ring and wedding rings, the groom's attire, the groom's gift to his groomsmen, his gift to the bride, all the boutonnieres and corsages for appropriate wedding party and family members, the officiant's fee plus accommodation and transportation to the wedding, the marriage license, lodging for the groomsmen, and transportation and lodging for the groom's family and groomsmen. Additionally, the groom's family often pays for the cost of the rehearsal dinner, and honeymoon.

Today, many couples or their parents still pay for cost of a wedding. While contributions to the cost of the wedding are generally negotiated according to willingness and ability of the couple and their families, the traditional allocations described above still often apply. Regardless of the how the expenses are allocated, the high cost of a wedding often places a severe financial burden on a couple and their associated families. As such, many modern couples choose to scale back on the costs associated with a wedding by choosing not to incur the above-mentioned costs, even though they desire to host a more elaborate event. While this frugality helps to allay the financial burden of the event, if often means that a couple does not get to have their desired wedding of their dreams. A lavish wedding remains one of the most visible means by which individuals can both demonstrate and enhance the quantity and quality of the social connections and/or status. Further, the pomp and circumstance of a wedding gives the couple, their family, and their invited guests, a luxury-laden event, which is often the result of months or years of detailed planning. As such, when desired elements of a wedding are unaffordable, it can detract from the enjoyment of the event.

In the face of the limitations and deficiencies of the above-described traditional systems for financing the cost of a wedding or other event, there remains a continuing and unresolved need for an event planning and financing system that allays the costs for a wedding couple, or other event holder and/or their families, that allows for said parties to enjoy a wedding or other event that meets said parties desired expectations, by including all desired event day services and related items.

Traditionally, people invited to events such as weddings, purchase a gift in anticipation of the event, which they hope will be well received and appreciated by the recipient. Unfortunately, this custom often results in unwanted or redundant gifts. Other occasions such as bridal showers, and birthdays experience similar issues of unwanted gifts or the duplication of gifts.

In order to prevent unwanted or redundant gifts, gift recipients (such as the bride and groom at a wedding) use a system known as a “registry.” In a registry, a recipient, such as a marrying couple, pre-shops a wish list of desired gifts from various retailers, which is then compiled under the recipient's name(s) and is then provided to the attendees of the event. Generally, a retailer “tracks” gift purchases and deletes gifts from the list or marks them as “purchased” as gift givers by the various listed items. This tracking by the retailer and indication. to the potential purchaser or gift giver avoids much of the redundancy of gift giving. Typically, a registry list comprises products to be purchased directly from a retailer chosen by the recipient. Modern online gift registry systems allow event attendees to easily purchase gifts from multiple retailers from any web accessible device.

While traditional and online gift registry systems have proven to be convenient, and help resolve the issue of unwanted or redundant gifts to a recipient, a gift of money is often the most practical and convenient gift and therefore the most appreciated. However, it can be considered. impolite or even tacky for a wedding couple to request attendees to give a gift of money. Compounding this is the issue of how the amount of money given for a gift should be determined. If a couple asks for a specific amount from all attendees, some guests may not be able to afford the monetary sum, similarly an attendee would consider it the height of rudeness to be asked to pay to attend an event. If the couple does not ask for a specific sum, some guests may choose not to donate anything to the couple. As such, couples often fill gift registries with numerous unneeded or unwanted items in order to give attendees a wide selection in the costs of gifts available for purchase. This often results in the couple being given gifts, which while chosen for the registry, are not truly desired. The consequence of the well-meaning, but undesired gift giving is stressful for gift recipients. Recipients are left with the chore of determining which items should be kept or potentially returned. This task is compounded by the social minefield of offending those parties whose gifts are returned. Therefore, many couples are forced to store numerous unneeded gifts, which only serve as a negative reminder of their special event. As a result, the problems associated with an event organizer requesting a gift of money remains.

Further complicating the issue of monetary gifts is that most event guests feel that simply giving money seems impersonal and lacking in warmth or sentiment. Event guests desire to provide a gift which would be individually recognized and appreciated by the recipient. Because of these feelings on the part of gift givers, the custom of giving specific tangible gift items rather than money has continued through the years. Thus, despite their advantages, gift registries have been proven to be subject to several limitations and the many practical advantageous and conveniences of money gifting have yet to be provided.

In the face of the limitations and deficiencies of the above-described event financing and event gifting systems, there remains a continuing and unresolved need in the art for gifting systems which exploits the overwhelming convenience and practicality of money gifting while providing wedding guests with the joys of more personal touch and feelings of participation of providing unique and recognizable contributions that allow a marrying couple to achieve the wedding of their dreams.

### OBJECTS AND SUMMARY OF THE INVENTION

Accordingly, it is a general object of the present invention to provide an alternative to the traditional methods of event financing and event gifting which eliminates the problems discussed above.

It is an object of the present invention to provide a service registry system that operates both as an alternative to the traditional system of gift giving and an inversion of the traditional process of financing the costs involved in holding an event, such as a wedding, bridal and baby showers, and the like

It is yet another object of the present invention to provide a novel event coordination system for an event venue or service provider including a service registry database and bill payment system containing event day related services and items provided by the venue for an event, that eliminates the problems discussed above.

Still another object of the present invention is to provide a revenue management system for an event venue or service provider which operates both as a novel means of collecting cash gifts and other income related to the purchase of goods or services related to specific events, as well as a unique method for an event organizer to allay the costs that arise from the organizing and execution of specific events or parties.

It is another object of the present invention to provide a new and improved event planning method and financing system that simplifies the processes of event planning by consolidating the selection and purchase of necessary services for an event though a single venue, with the added benefit of consolidated revenue streams for the venue and/or service provider.

It is a more particular object of the present invention to provide a service registry system for use in traditional events such as weddings, bridal showers, baby showers, birthdays and the like that allows that gives contributors, who have been preselected by an event organizer, means to access an online registry database, where event day services and items can be purchased from the venue and/or service provider by contributors on behalf of the event organizer.

In accordance with the present invention, there is provided a method for an event venue and/or service provider to provide a service registry to an event organizer comprising the steps of: creating, by an event organizer, an account with the service registry provider, establishing a service registry in the name of an event organizer, said service registry containing a list of event day services and items each of which is associated with a price representing its cost as defined by the service registry provider, receiving the selection of event day offerings from the event organizer for inclusion in its unique service registry, making available the service registry for online access to third party contributors, receiving from third party contributors cash purchases of event day related services and items contributed in the name of the event organizer, updating the service registry after services are purchased, accounting to the event organizer for the services purchased, and providing the purchased services to the event organizer at the event.

The invention also provides a method of providing a service registry in which an event organizer registers with a venue to establish a service registry comprising the steps of: establishing a dedicated service registry for the event organizer, presenting the dedicated service registry to a plurality of internet users, receiving gifts in cash amounts from a plurality of internet users who have selected to purchase specific services from the service registry, updating the service registry and the event organizer's account with services purchased by internet users, and the venue providing the event organizer with the purchased services at the event.

In some embodiments, the present invention includes a method for singly or collectively giving a cash gift via an online environment comprising receiving a request to establish an account with a venue from an event organizer, receiving an identity of an event organizer, creating a dedicated service registry for the event organizer accessible via a unique web address, providing event day services and items offered by the venue which are available for selection by the event organizer for inclusion in the dedicated service registry, associating each service available in the service registry with a specific price, receiving the selection of specific services for inclusion in the service registry from the event organizer, creating a website for the event organizer's event with access to event organizer's service registry, providing access to the event organizer's website and service registry to third parties selected by the event organizer via unique login information or unique html address, providing means to allow selected third parties to purchase services from the service registry, updating the event organizer's website and service registry with the purchased items, and the venue providing the event organizer with the purchased services at the event.

In some embodiments, the event financing method and system proposed herein, also referred to as a service registry, allows an event organizer, in general, and brides and grooms, in particular, the ability to focus on the overall results desired in event planning without becoming entangled in the mechanics of searching for vendors and coordinating their various services by having a single service provider, such as an event venue, provide the necessary event day related services, items, and vendors for purchase in the service registry. In addition, the service registry allows for additional revenue for the venue by consolidating the purchase of all event day related services and items through its service registry. The service registry transforms the event planning and financing process by creating an online database that collects, links and coordinates all event day related services, which are available for purchase by third parties for the benefit of the event organizer. By listing the cost of all event day related vendors, services, products, and the like offered by the venue, an event organizer can select all desired available services it wishes for an event, and request attendees of the event to assist with the financing of the desired elements, without incurring the cost of the service. Further, the service registry allows event attendees to purchase a service as a gift to the event organizer at various budgetary levels in lieu of a traditional tangible or monetary gift. Additionally, the service registry allows both an event organizer and event attendees to mutually choose whether their purchase of a service is made publicly viewable to other event attendees or remains private. Further, the service registry system allows an event organizer the option to choose to have the venue send a thank you to a contributing party for its purchase and/or create a thank you card placed next to purchased item. with the identity of the contributor at the event. Additionally, gift providers receive the benefit of being able to enjoy the gift they provided with the event organizer.

In some embodiments, the event financing method and system proposed herein, requires that any cash or other gifts that do not meet the price defined by the service registry will not be returned to the gift provider or event host, but rather must be used to purchase other items in the event registry.

In some embodiments, the event financing method and system proposed herein may be provided to third party venues, which may use it to allow an event organizer to host events via the third-party venue.

### BRIEF DESCRIPTION OF THE DRAWINGS

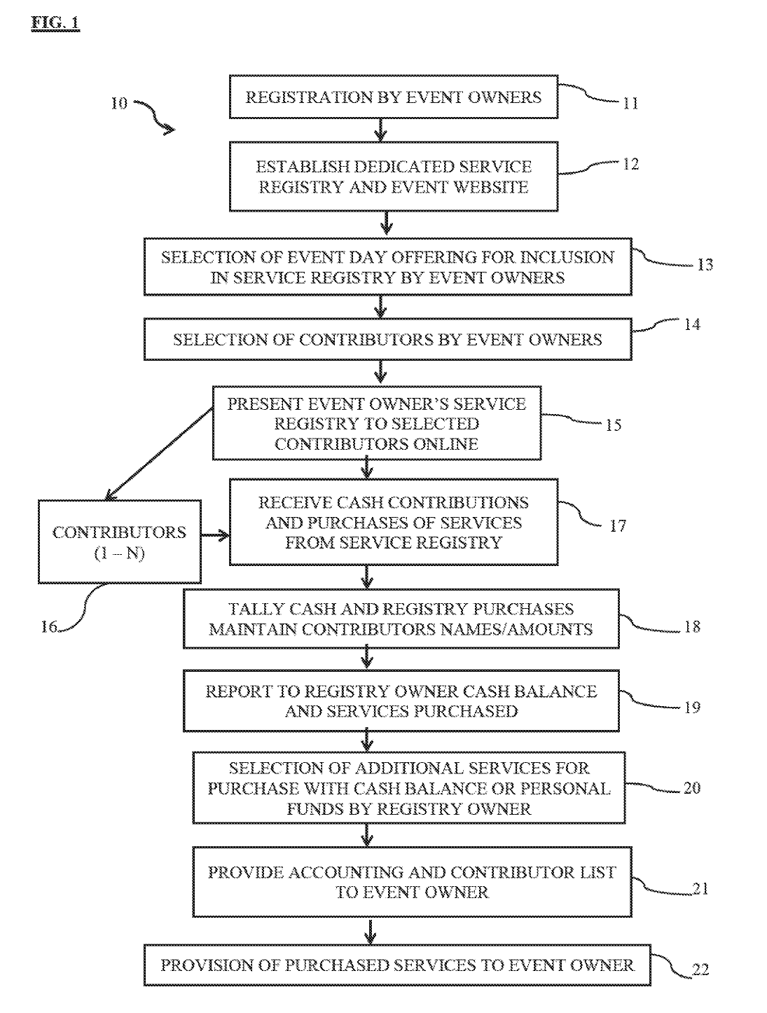

The features of the present invention, together with further objects and advantages thereof, may best be understood by reference to the following description taken in conjunction with the accompanying drawing, in which like reference numerals identify like elements and in which: FIG. 1 sets forth a flow diagram for the present invention service registry system.

### DESCRIPTION OF THE PREFERRED EMBODIMENT OF THE INVENTION

FIG. 1 sets forth a flow diagram of the operation of the present invention of a service registry system generally referenced by numeral 10. System 10 is characterized by an initial step 11 at which an event organizer or organizers to enter into the establishment of a unique service registry with the service registry provider that is tied to a particular event. The service registry provider, is typically the proprietor of the venue for the event, alternatively, the service registry provider may offer customizable service registries to third parties, or other venues via an online website, mobile app, or the like, who can use it to perform the services described below. An important feature of the registry provider is the capability to establish and maintain the individual service registry as well as relevant data required by the event organizer and to have sufficient resources and online capability to receive cash flow from contributors and functionality for the present invention system, and also to ensure the provision of the purchased event day services and items at the event. Once the initial registration has taken place at step 11, the operation moves to a step 12 in which the registry provider establishes a dedicated service registry for an upcoming event related to the event organizer. Following the establishment of a dedicated service registry at step 12, the system moves to a step 13 in which an event organizer is able to view the array of event day services and items available for purchase at the event, (hereinafter referred to as “event day offerings,” as wells as the purchase price of each the event day offerings. The event organizer then customizes their dedicated service registry by selecting those event day offerings that they desire to be made available and/or performed at their event. Each of the event day offerings, and their respective prices, are then included in an event organizer's registry, which will be subsequently made available online to those third parties selected by the event organizer. At this step, an event organizer is also able to include details and information about the event and the organizer in their customized service registry. Following customization of the dedicated service registry at step 13, the system moves to a step 14 in which the event organizer selects third parties who they believe would be willing to contribute to funding the event. The event organizer provides the name and contact information for the selected contributors via its account with the service provider.

Following the selection of event contributors at step 14, the system moves to a step 15 in which the registry provider utilizes its online capability to present the event organizer's service registry in a user accessible online presentation to the potential contributors selected by the event organizer. While a variety of systems may be used, the anticipated form of this presentation involves the use of one or more online websites or mobile apps operated by the registry provider for the benefit of the event organizer. In some embodiments, a unique service registry may be hosted on a publicly accessible unique html address. Alternatively, access to a service registry may require login credentials. Thus, a host website, which provides links to individual registries, may be utilized by the registry provider to allow third parties that have been preselected by the event organizer to access the desired service registry and interact on an online basis. Alternatively, the system may be hosted on multiple websites.

At step 17, the registry provider accumulates and receives cash for the purchase of the event organizer's selected services that are provided at step 16 by a plurality of event contributors. While the number of contributors is indefinite in any given situation, the essential function at step 17 is the accurate accumulation of all monetary amounts given by a contributor and the verification that the purchase price of a service has been reached. In the anticipated operation of the present invention system, virtually any valid cash transfer apparatus will be available to gift purchasers and will be maintained by the registry provider with the essential function being the transfer of funds from the gift purchasers to the service registry for accumulation at step 17. Thus, for example, the registry provider would be capable of receiving funds by direct cash payment such as checks or the like, direct bank wire transfers from the gift giver's account, cash transfers from credit cards held by gift contributors as well as other forms of PayPal or wire transfer or the like.

For a predetermined time prior to an event, cash contributions flow into the registry at step 17 and are thereafter tallied at step 18. The time interval for cash contributions may be established in anticipation of a particular event such as a wedding day or the like. At step 18, the registry provider accumulates contributions to the event organizer and maintains an accurate list of giver names and amounts given for later use by event organizer. Following the accumulation and creation of appropriate accounting statements and lists of contributors and amounts given at step 18, at step 19 the system then provides an accounting to the registry event organizer in the form of a list of all purchased services and related items. At step 19, the service registry will. provide an event organizer with a frequently updated list of all items that have been purchased by contributors. Further, at step 19 the service registry will update the event organizer website to ensure that contributors are aware of what items have been purchased, and which services are still available for purchase.

At step 19, a final accounting, prior to the date of the event, will be provided to an event organizer detailing the services and items purchased for the event. Having the cash total accounting at step 19, system moves to a decision step 20 in which the event organizer may elect to purchase additional services that were not fully funded or completely purchased by contributors. Additionally, at step 20, if contributors made a cash donation not directed to a specific service registry item, the event organizer can choose to use the nonspecific cash contributions for the purchase of additional items from the service registry, or to pay off any balance owed to the service registry provider and/or venue.

If no additional services are selected for purchase by the event organizer, then at step 21, the service registry provider will provide a final statement detailing all services and items that were purchased, and thus will be provided to the event organizer at the event. Additionally, the service registry provider will provide the event organizer with an accounting of all contributions received and expended, as well as a contributor list containing the identity of each contributor, the amount contributed, and the service registry items purchased thereby. The provision of the final accounting at step 21 allows an event organizer to maintain accurate receipts and information as to contribution funds taken and funds expended as well as to properly respond to contributors using the list of contributors and amounts given. Finally, at step 22, the service registry provider supplies all purchased services and items at the event.

Thus, the present invention of a service registry system generally referenced by numeral 10 in FIG. 1 will be understood to provide substantial advantages over the previous systems. These advantages include ease of operation by an event organizer and contributors together with a security and protection for collection of funds for use in financing an event organizer's desired event. Further, the system provides an advantage to an event organizer in the streamlined selection process of the necessary vendors, services, and items for an event through a service registry. It will be apparent to those skilled in the art that an event organizer having access to collective funds provided by contributors allows said organizer to conduct an event incorporating all the items and services it desires to create its ideal event. This, system in effect, greatly reduces the cost typically incurred by an event organizer in holding an event, while allowing the event organizer to have benefit of all such items and services. Further, it not only allows contributors to participate in a personal and meaningful way in the establishment of the event; it also allows contributors an alternative to the problems associated with giving tangible gifts or impersonal cash gifts at traditional events.

By way of summary, the present invention will be recognized as a convenient and extremely practical alternative to the prior art systems utilized by an event organizer and/or their families for funding the cost of events as traditionally exercised in the past. The present invention service registry system allows individuals to sign up to collect accumulated cash contributions which contributors may give in a selected amount or nonspecific amount for the purchase of specific services or items. At the completion of a contribution period, which occurs prior to the event, the event organizer may choose to use any nonspecific cash contributions to purchase of additional event related items or services, or pay off any balance owed to the service registry provider. Additionally, the event organizer may elect to purchase additional items and services for the event with their own funds. One of the important aspects of this invention provided to the event organizer is found in the simplification of the service registry provider offering the vendors, services, and items typically necessary for an event in its service registry, thereby simplifying the typical procedure in which an event organizer must contact and contract with multiple vendors or retailers to arrange for provision of the services and items necessary for a particular event. Further, by consolidating the selection of available vendors and service providers into the service registry, and requiring that contributed funds be paid to the service registry provider for the provision of the purchased services, the service registry provider receives the benefit of receiving additional revenue that is traditionally paid to various unrelated vendors and service providers.

In the preferred embodiment, the service registry provider provides the items and services available in the service registry. However, in an alternate embodiment, the service registry provider can contract with unrelated merchants, vendors, and service providers for inclusion of their various goods and services in a service registry. Service registry providers would then advertise the goods and services of contracting merchants, vendors, and service providers on the service registry website for purchase by event contributors. In return, merchants, vendors, and service providers would pay a fee to registry service provider for inclusion in the registry and/or a percentage of the cost of any items or services that are purchased by contributors via an event organizer's unique service registry.

In addition to providing specific prices for the items and services in a service registry, the service registry provider may also allow an event organizer to include the option to allow contributors to give established gift level amounts such as ten dollars, twenty-five dollars, one hundred dollars, one thousand dollars and so on or, alternatively, may invite contributors to choose their own gift amount. Because event items and services tend to be high dollar items, the inclusion of nonspecific cash donations allows contributors to make donations that fit their individual budget. The nonspecific cash amounts are pooled in the event organizer's account, and the total amount is reported to the event organizer. The event organizer can then choose to apply the cash amounts to purchase items in the service registry or pay any outstanding balance to the service registry provider.

What has been shown is a novel service registry system that provides an event planning and service registry system having ease of operation by event contributors and practical protections and advantages to the event organizer for the financing of an event. The system further provides a convenient operative mechanism by which a registry service provider may ensure that event related items and services are purchased from it in order to maximize revenue. Alternatively, various merchants, vendors, and service providers may choose to enter into agreements with the service registry provider to be featured in a service registry in return for various forms of compensation to the service registry provider.

While particular embodiments of the invention have been shown and described, it will be obvious to those skilled in the art that changes and modifications may be made without departing from the invention in its broader aspects.

The invention claimed is:

1. A method for a service registry provider to provide an online event planning registry that allows an event organizer to arrange for the collective funding of event related services, the method comprising:
receiving, at the service registry provider's website, a request by an event organizer or organizers, to register with the website in order to establish a unique service registry for the organizer's event;
creating a service registry for the registered organizer's event that contains an on-line database of the services available to be provided by the service registry at the organizer's event;
providing for the customization of the organizer's service registry by allowing the event organizer to tailor the registry by selecting desired event services;
receiving the contact information of potential third-party contributors via the organizer's account and then delivering the event organizers' service registry via the internet to the identified contributors;
enabling the third-party contributors to make monetary donations or select one or more services to contribute funding to on behalf of the event organizer;
accumulating third-party contributions and maintaining an accurate accounting of contributor's donations;
providing event organizers and third-party contributors with an updated accounting of all partially or fully funded services;
enabling the organizer to use cash donations, money from partially funded services, or the organizer's own resources to purchase services in the registry prior to the event; and
providing the fully funded services to the event organizer at the event.

2. The method of claim 1, wherein the step of creating the service registry comprises: providing a website to enable creation of unique database, displaying options of different services to the organizer at the website, and displaying the price of each service.

3. The method of claim 2, wherein the step of customizing the service registry comprises:
displaying the various types of services available to the organizer at an event, displaying the prices for each available service to the organizer, enabling the selection of specific services by the organizer, whereby the organizer is able to tailor its registry to contain only the services it wishes to be provided at an event.

4. The method of claim 3, further comprising: upon access of the third parties to the service registry, presenting them with an option to give a monetary gift to the event organizer; and enabling the organizer to apply the monetary gift to purchase services in the service registry or to pay off any balance owed to the service registry provider.

5. The method of claim 4, wherein the step of enabling the third-party contributors to make monetary donations comprises: enabling the third-party contributors to make donations via traditional methods, such as cash, check, or wire transfer, or through various forms of electronic payment, such as credit card, PayPal, Bitcoin, etc.

6. The method of claim 5, further comprising allowing an event organizer the option to choose whether donations made by contributors are viewable to other contributors with access to the service registry or remain private.

7. The method of claim 6, further comprising allowing third parties who have donated to either remain anonymous or display their name and the amount of money donated or service purchased on the service registry.

8. The method of claim 7, wherein the step of delivering the event organizers' service registry via the internet to the potential third-party contributors comprises: providing a unique URL to third-party contributors that enables such contributors to follow the URL to a website containing information about the event, or via an online website that requires a form of authentication, such as an email address, password, unique code, or the like.

9. The method of claim 8, further comprising limiting access to the service registry only to third parties that were invited by the organizer to the event.

10. The method of claim 8, wherein the method proposed herein, requires that any cash or donations by third-parties that do not meet the price defined by the service registry will not be returned to the gift provider or event organizer, but rather must be used to purchase other items in the service registry.

11. The method of claim 8, further comprising allowing an event organizer the option to choose to have the venue send a thank you message to a contributing party for its donation following the event.

12. The method of claim 11, further comprising allowing an event organizer the option to create a thank you placard, the identity of the contributor to be placed near each purchased service at the event.

13. A method for a service registry provider to provide an online event planning registry to a third-party venue, which would allow such venue to offer its services to be purchased by event organizers via collective funding, the method comprising:
receiving, at the service registry provider's website, a request by a third-party venue, to register with the website in order to establish a unique service registry for the venue;
creating a service registry for the venue that contains an on-line database to host the services the venue wishes to offer for sale to event organizers;
providing for the customization of the venue's service registry by allowing the venue to tailor the registry by providing information regarding the types of services it offers and the costs for such services to an event organizer;
publishing the venue's service registry online in the form of a website and allowing a third-party event organizer to register with the website in order to establish a unique service registry for the organizer's event;
providing for the customization of the organizer's service registry by allowing the event organizer to tailor the registry by selecting desired event services offered by the venue;
receiving the contact information of potential third-party contributors via the organizer's account and then delivering the event organizers' service registry via the internet to the identified contributors;
enabling the third-party contributors to make monetary donations or select one or more services to contribute funding to on behalf of the event organizer;
accumulating third-party contributions and maintaining an accurate accounting of contributor's donations;
providing event organizers and third-party contributors with an updated accounting of all partially or fully funded services;
enabling the organizer to use cash donations, money from partially funded services, or the organizer's own resources to purchase services in the registry prior to the event;
providing the venue with an updated accounting of all partially or fully funded services prior to the event;
delivering to the venue any moneys collected by the service registry from the third-party contributors less any costs or fees; and
instructing the venue to provide the fully funded services to the event organizer at the event.

14. The method of claim 13, wherein the step of customizing the service registry comprises:
displaying the various types of services available to the organizer at an event, displaying the prices for each available service to the organizer, enabling the selection of specific services by the organizer, whereby the organizer is able to tailor its registry to contain only the services it wishes to be provided at an event.

15. The method of claim 14, wherein the step of creating the service registry comprises:
providing a website to enable creation of unique database, allowing a venue to identify the services it offers to event organizers and displaying the price the venue charges for each service.

16. The method of claim 15, further comprising: upon access of the third parties to the service registry, presenting them with an option to give a monetary gift to the event organizer; and
enabling the organizer to apply the monetary gift to purchase services in the service registry or to pay off any balance owed to the service registry provider.

17. The method of claim 16, wherein the step of enabling the third-party contributors to make monetary donations comprises: enabling the third-party contributors to make donations via traditional methods, such as cash, check, or wire transfer, or through various forms of electronic payment, such as credit card, PayPal, Bitcoin, etc.

18. The method of claim 17, further comprising allowing an event organizer the option to choose whether donations made by contributors are viewable to other contributors with access to the service registry or remain private.

19. The method of claim 18, further comprising allowing third parties who have donated to either remain anonymous or display their name and the amount of money donated or service purchased on the service registry.

20. The method of claim 19, wherein the step of delivering the event organizers' service registry via the internet to the potential third-party contributors comprises: providing a unique URL to third-party contributors that enables such contributors to follow the URL to a website containing information about the event, or via an online website that requires a form of authentication, such as an email address, password, unique code, or the like.

21. The method of claim 20, further comprising limiting access to the service registry only to third parties that were invited by the organizer to the event.

22. The method of claim 20, wherein the method proposed herein, requires that any cash or donations by third-parties that do not meet the price defined by the service registry will not be returned to the gift provider or event organizer, but rather must be used to purchase other items in the service registry.

23. The method of claim 20, further comprising allowing an event organizer the option to choose to have the venue send a thank you message to a contributing party for its donation following the event.

24. The method of claim 23, further comprising allowing an event organizer the option to create a thank you placard, the identity of the contributor to be placed near each purchased service at the event.

25. A method for an event venue and/or service provider to provide a service registry to an event organizer comprising the steps of:
creating, by an event organizer, an account with the service registry provider,
establishing a service registry in the name of an event organizer, said service registry containing a list of event day services and items each of which is associated with a price representing its cost as defined by the service registry provider,
receiving the selection of event day offerings from the event organizer for inclusion in its unique service registry,
making available the service registry for online access to third party contributors,
receiving from third party contributors cash purchases of event day related services and items contributed in the name of the event organizer,
updating the service registry after services are purchased,
accounting to the event organizer for the services purchased, and
providing the purchased services to the event organizer at the event.
